(19) United States
(12) Patent Application Publication
(10) Pub. No.: US 2018/0105376 A1
(43) Pub. Date: Apr. 19, 2018

(54) DEVICE FOR FEEDING PARTS TO A MANUFACTURING SYSTEM

(71) Applicant: CHAD JOSEPH ROBERTS, Gulfport, FL (US)

(72) Inventor: CHAD JOSEPH ROBERTS, Gulfport, FL (US)

(21) Appl. No.: 15/783,937

(22) Filed: Oct. 13, 2017

Related U.S. Application Data
(60) Provisional application No. 62/408,180, filed on Oct. 14, 2016.

(51) Int. Cl. B65G 65/40

(52) U.S. Cl. CPC B65G 65/40; B65G 2201/02

(57) ABSTRACT

A device for feeding parts to a manufacturing system, the device includes a housing that with a base at a lower end of the housing and a hopper at an upper end. A double action cylinder drive is fixed to the base of the housing. An end of a piston is fixed to a drive lever in a by a hinge mechanism, and a cam follower is secured to the drive lever with the cam follower spaced apart from the piston rod. Vertically extending spaced apart guide rods are fixed to the base plate inside the housing. each guide ford provided with a linear bearing that slides along the guide rod; and A dynamic part feeding plate that is fixed to a mounting member which in turn is fixed to each of the linear bearings. The mounting member provided with a cam member having a cam profile surface that mates with the cam follower of the driver assembly drive lever to move the dynamic feeding plate vertically through the hopper of the housing along a wall of the hopper.

This nonprovisional application claims priority of provisional patent application 62/408,180 filed Oct. 14, 2016.

### FIELD OF THE INVENTION

The present invention relates to a device used with an automated manufacturing system for deeding parts to the manufacturing system.

### SUMMARY OF INVENTION

The step feeder of the present invention for feeding parts to a manufacturing system is unique in that it utilizes a drive assembly which allows for a smaller foot print and increased piston stroke length. The increased piston stroke length is desirable to obtain greater hopper capacity.

### BRIEF DESCRIPTION OF THE DRAWINGS

FIGS. 1 to 27 show a first embodiment of a device of the present invention for feeding parts to a manufacturing system.

FIG. 1 is a perspective view of a completely assembled device of the present invention for feeding parts to a manufacturing system.

FIG. 2 is a top view of the completely assembled device.

FIG. 3 is a rear elevation view of the completely assembled device.

FIG. 4 is a side elevation view of a first lateral side of the completely assembled device.

FIG. 5 is a side elevation view of a second lateral side of the completely assembled device.

FIG. 6 is a perspective view of a frame assembly of the device of the present invention for feeding parts to a manufacturing system.

FIG. 7 is a top view of the frame assembly.

FIG. 8 is a front view of the frame assembly looking in the direction of arrow 8 in FIG. 6.

FIG. 9 is a side view of the frame assembly looking in the direction of arrow 9 in FIG. 6.

FIG. 10 is a rear view of the frame assembly looking in the direction of arrow 10 in FIG. 6 with the back plate of the assembly removed.

FIG. 11 is a side view of a drive assembly of the device of the present invention for feeding parts to a manufacturing system.

FIG. 12 is a top view of the drive assembly.

FIG. 13 is a section view of the drive assembly taken at line 13-13 of FIG. 12.

FIG. 14 is a side view of the drive assembly looking in the direction of arrow 14 in FIG. 11.

FIG. 15 is a perspective view of a carriage assembly of the device of the present invention for feeding parts to a manufacturing system.

FIG. 16 is a side view of the carriage assembly.

FIG. 17 is a bottom view of the carriage assembly.

FIG. 18 is a front elevation view of the carriage assembly.

FIG. 19 is a section view of the carriage assembly taken at line 19-19 of FIG. 18.

FIG. 20 is a perspective view of the completely assembled device of the first embodiment of the present invention for feeding parts to a manufacturing system partially broken away to show the carriage assembly and drive assembly located inside the frame assembly.

FIG. 21 is an enlarged detail of FIG. 20 showing the connection of the drive assembly to the carriage assembly.

FIG. 22 is a rear elevation view of the completely assembled device of the present invention for feeding parts to a manufacturing system with the rear panel of the frame assembly removed to show the drive assembly and frame assembly, with the carriage assembly at the lowest extend of its travel.

FIG. 23 is a section view of the completely assembled device taken at line 23-23 of FIG. 22.

FIG. 24 is like FIG. 22 with the with the carriage assembly part way between the lowest and highest extend of its travel.

FIG. 25 is a section view of the completely assembled device taken at line 25-25 of FIG. 24.

FIG. 26 is like FIG. 22 with the carriage assembly at the highest extent of its travel.

FIG. 27 is a section view of the completely assembled device taken at line 27-27 of FIG. 26.

FIGS. 28 to 34 show changes that may be made to the device of the first embodiment to reduce the number of parts and improve the operation of the device.

FIG. 28 is a perspective view of the dynamic part feeding assembly comprising a dynamic part feeding plate assembled with a mounting plate.

FIG. 29 is a first elevation view of the dynamic part feeding assembly.

FIG. 30 is a second elevation view of the dynamic part feeding assembly showing a side of the assembly opposite the side shown in FIG. 29.

FIG. 31 is a side elevation view the dynamic part feeding assembly.

FIG. 32 is a top view of the cam plate that is fixed to the mounting plate of the dynamic part feeding assembly.

FIG. 33 is a is a perspective view of the completely assembled device of the second embodiment of the present invention for feeding parts to a manufacturing system partially broken away to show the dynamic part feeding assembly and drive assembly located inside the frame assembly.

FIG. 34 is an enlarged detail of FIG. 33 showing the connection of the dynamic part feeding assembly to the guide rods.

### DETAILED DESCRIPTION OF THE INVENTION

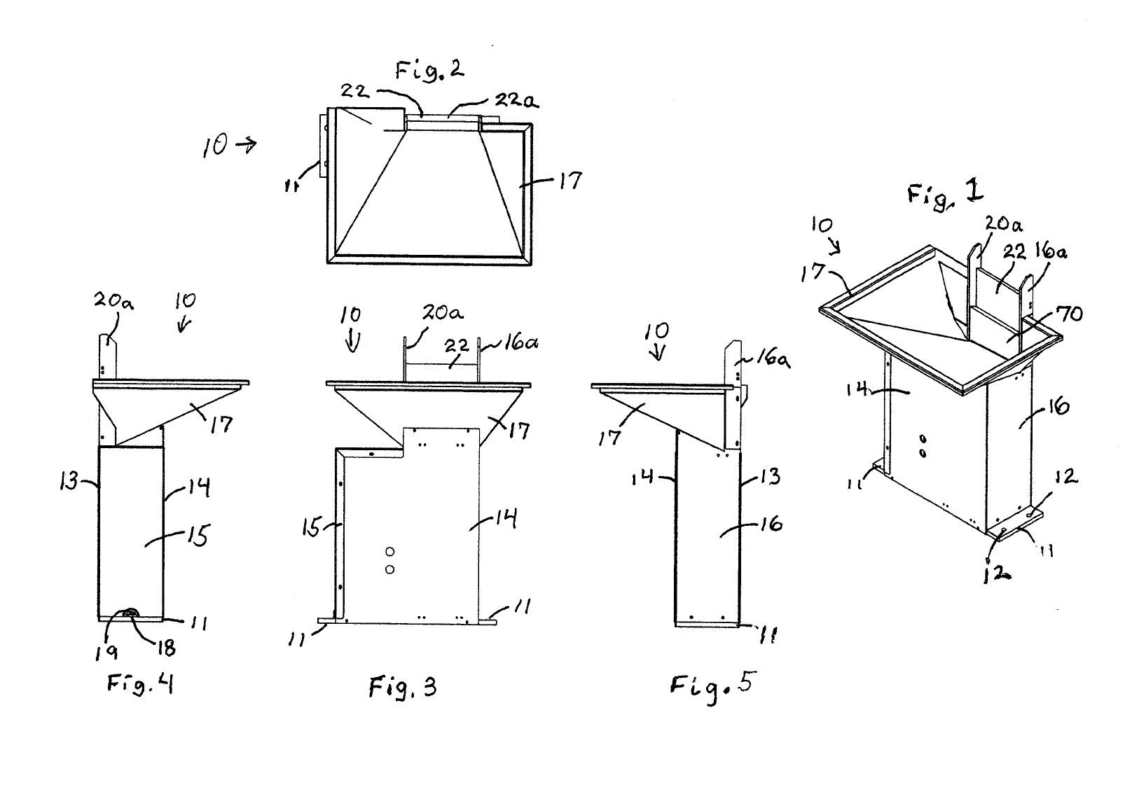

Referring first to FIGS. 1 to 27 there is shown a first embodiment of the present invention for feeding parts to a manufacturing system. FIGS. 1 to 5 there is show a completely assembled device 10 of a first embodiment of the present invention for feeding parts to a manufacturing system. FIG. 1 is a perspective view of the device; FIG. 2 is a top view of the device; FIG. 3 is a rear elevation view of the device; FIG. 4 is a side elevation view of a first lateral side of the device; and FIG. 5 is a side elevation view of a second lateral side of the device.

A frame assembly of the device 10 has a base 11. As shown the base 11 is provided with mounting holes 12 allowing the use of suitable fasteners for fixing the device 10 to a manufacturing system (not shown). A front plate 13 and a back plate 14 extend substantially vertically from the base with the front plate and back plate spaced apart in a substantially parallel relationship. A side plate 16 is located at one end of the front and back plates with the side plate extending substantially vertically from the base and fixed to both the front and back plates with appropriate fasteners or other suitable means for fastening such as welds. A side cover 15 is adjacent to the front 13 and back 14 plates and the base with the side cover extending substantially vertically from the base and fixed to both the front and back plates with appropriate fasteners to facilitate attachment and removal of the side cover. As shown the side cover 15 is provided with a notch 18 for facilitating the passage of tubes and electrical conductors through the frame assembly. A hopper 17 is located at the top of the device for receiving parts that are fed to a manufacturing system by the device 10.

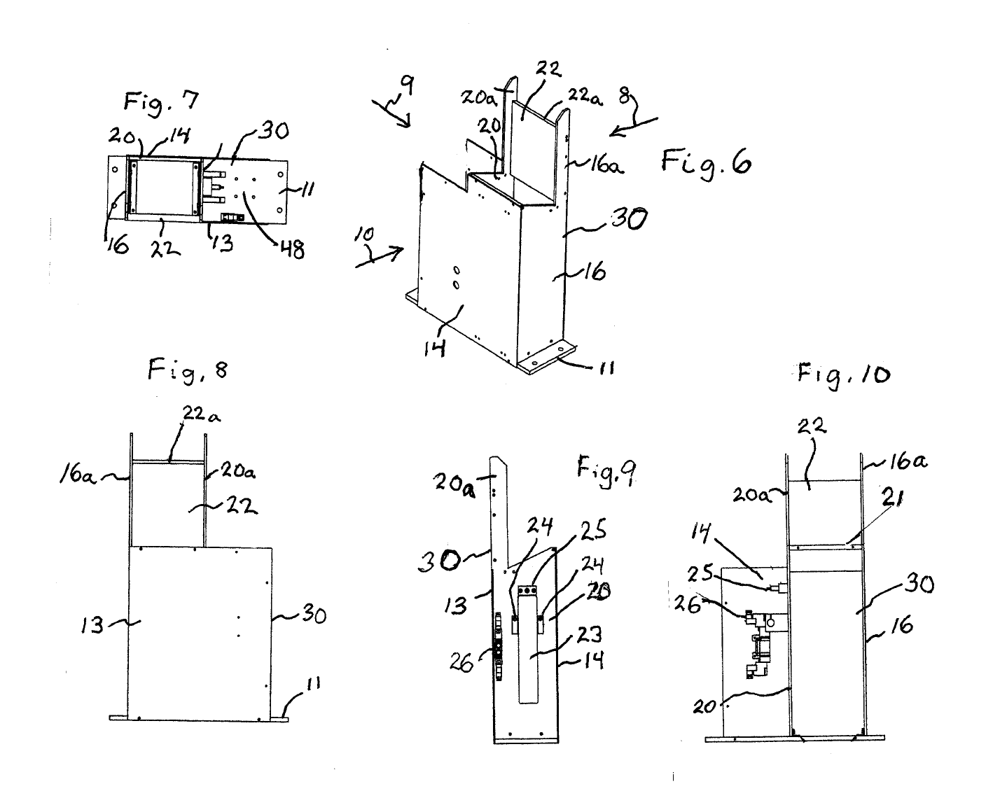

Additional features of the device 10 of the present invention for feeding parts to a manufacturing system are best understood by considering FIGS. 1 to 5 in conjunction with FIGS. 6 to 10. FIGS. 6 to 10 show the frame assembly 30 by itself without the hopper 17 or side cover 15 or any of the other functioning assemblies that will be disclosed below.

FIG. 6 is a perspective view of the frame assembly 30; FIG. 7 is a top view of the frame assembly; FIG. 8 is a front view of the frame assembly 30 looking in the direction of arrow 8 in FIG. 6; FIG. 9 is a side view of the frame assembly looking in the direction of arrow 9 in FIG. 6; and FIG. 10 is a rear view of the frame assembly looking in the direction of arrow 10 in FIG. 6 with the back plate 14 of the frame assembly removed.

In it can be seen in FIGS. 6 to 10 that the frame assembly 30 includes in addition to the side plate 16 (visible in FIGS. 1 and 5) a second side plate 20. The second side plate 20 extends substantially vertically from the base 11. The second side plate 20 is located between the front plate 13 and the back plate 14 and fixed to both the front and back plates. Each of the side plates 16, 20 includes a vertically extending support post portion 16a, 20a. The vertically extending support post portions 16a, 20a are narrower than the remainder of the side plates 16, 20. A cross bar 21 extends between the vertically extending support post portions 16a, 20a to stabilize the structure. A stationary part feeding plate 22 is suspended and held in place with appropriate fasteners and extends between the vertically extending support post portions 16a, 20a. A top edge 22a of the stationary plate 22 is beveled. A portion of a dynamic part feeding plate 70 that cooperates with the stationary plate 22 is visible in FIG. 1. to facilitate the feeding of parts to a manufacturing system (not shown) in a manner that will be described below.

Referring specifically to FIG. 9 there is shown a side view of the frame assembly looking in the direction of arrow 9 in FIG. 6 with the side cover 15 of the device removed. The second side plate 20 is provided with an elongated passage 23 for receiving a component of a drive assembly in a manner that will be disclosed below. Pivot blocks 24 are fixed to the second side plate 20 to accommodate a component of a drive assembly in a manner that will be disclosed below.

Referring to FIG. 10 along with FIG. 9, FIG. 10 is a rear view of the frame assembly looking in the direction of arrow 10 in FIG. 6 with the back plate of the assembly removed. A bumper 25 is fixed to the second side plate 20 to interact with a component of a drive assembly in a manner that will be disclosed below. An air control valve assembly 26 is fixed to the second side plate 20 to interact with a component of a drive assembly in a manner that will be disclosed below.

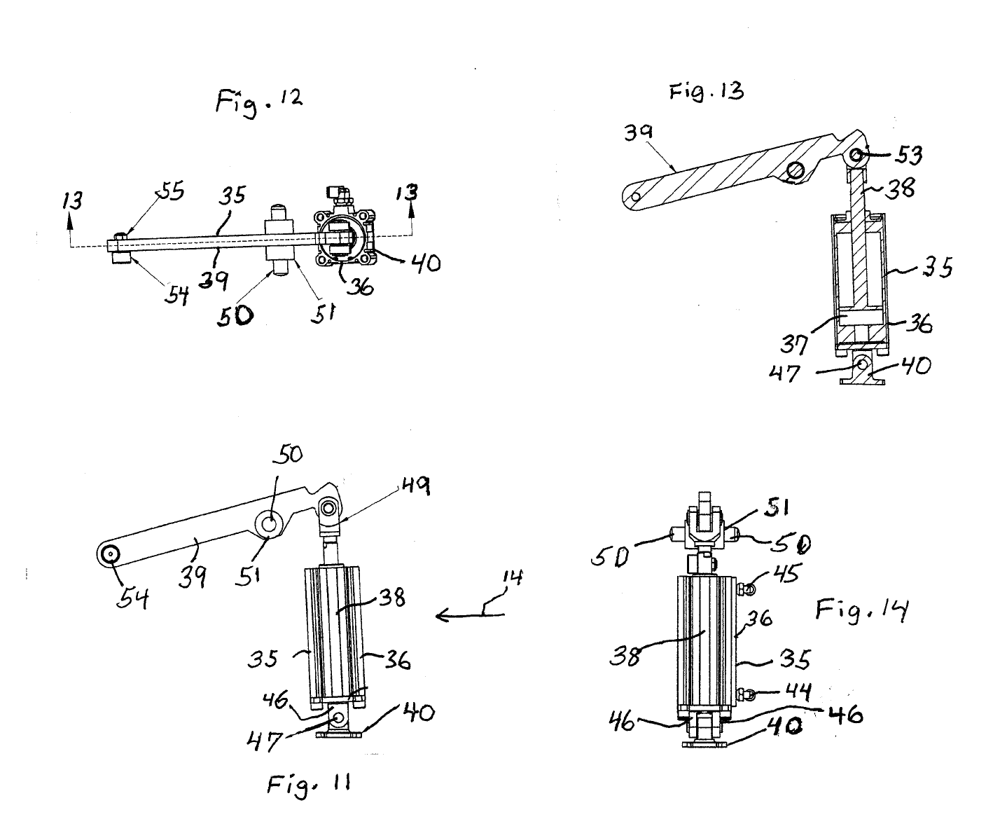

Additional features of the device 10 of the present invention for feeding parts to a manufacturing system are best understood by considering FIGS. 11 to 14 which show a drive assembly 35 of the device of the present invention for feeding parts to a manufacturing system. FIG. 11 is a side view of a drive assembly 35; FIG. 12 is a top view of the drive assembly; FIG. 13 is a section view of the drive assembly taken at line 13-13 of FIG. 12; and FIG. 14 is a side view of the drive assembly looking in the direction of arrow 14 in FIG. 11. The drive assembly 35 shown in the drawings comprises a double action pneumatic cylinder device. However it is understood that a double action hydraulic cylinder or a double action electromagnetic cylinder device that provides the same kinematic motion of the drive assembly as the exemplary pneumatic device may be used in the practice of the present invention.

A pneumatic cylinder 36 (sometimes known as an air cylinder) is a mechanical device which uses the power of compressed gas to produce a force in a reciprocating linear motion. Compressed gas forces a piston 37 to move in a linear direction. The piston 37 is a disc, and a piston rod 38 transfers the force it develops to a drive lever 39. The double-acting pneumatic cylinder uses the force of air to move in both extending and retracting strokes. The double-acting pneumatic cylinder has two ports 44, 45 to allow air into the cylinder 36. One port 44 allows air into the cylinder 36 for an extending stroke and one port 45 allows air into the cylinder for a retracting stroke.

One end of the cylinder 36 is provided with a double clevis 46 that mates with a double clevis pivot bracket 40 and a pivot pin 47 passes through the double clevis 46 and double clevis pivot bracket 40 to allow a lower end of the cylinder 36 to pivot. In the assembled device 10 of the present invention for feeding parts to a manufacturing system the double clevis pivot bracket 40 is secured by suitable fasteners to the base 11 of the device at a location indicated in FIG. 7 as 48.

An end of the piston rod 38 distal from the piston 37 is fixed to the drive lever 39 by clevis 49 and a short flange bearing 53 allowing drive lever 39 to pivot with respect to the piston rod. A dowel pin 50 extends through the drive lever 39 with spacers 51 mounted on the dowel pin on either side. A cam follower 54 is secured to the drive lever by a lock nut 55 near the end of the drive lever that is distal from the piston rod 38. In prototypes of the device of the present invention the short flange bearing 53 was an oil impregnated brass bearing, but it has been determined that the device operates more efficiently and is more durable when the bearing 53 and the assembly 50, 51 are replaced with appropriately mounted needle bearings. A needle bearing is a roller bearing with very slender rollers, or put another way a type of roller bearing in which the load bearing elements are longish thin cylindrical pins. The surface area of the slender rollers and the high number of rolling load-bearing elements have exceptional load capacity and stiffness.

Details of the operation of the drive assembly 35 interacting with other components of the completely assembled device of the present invention for feeding parts to a manufacturing system will be disclosed below.

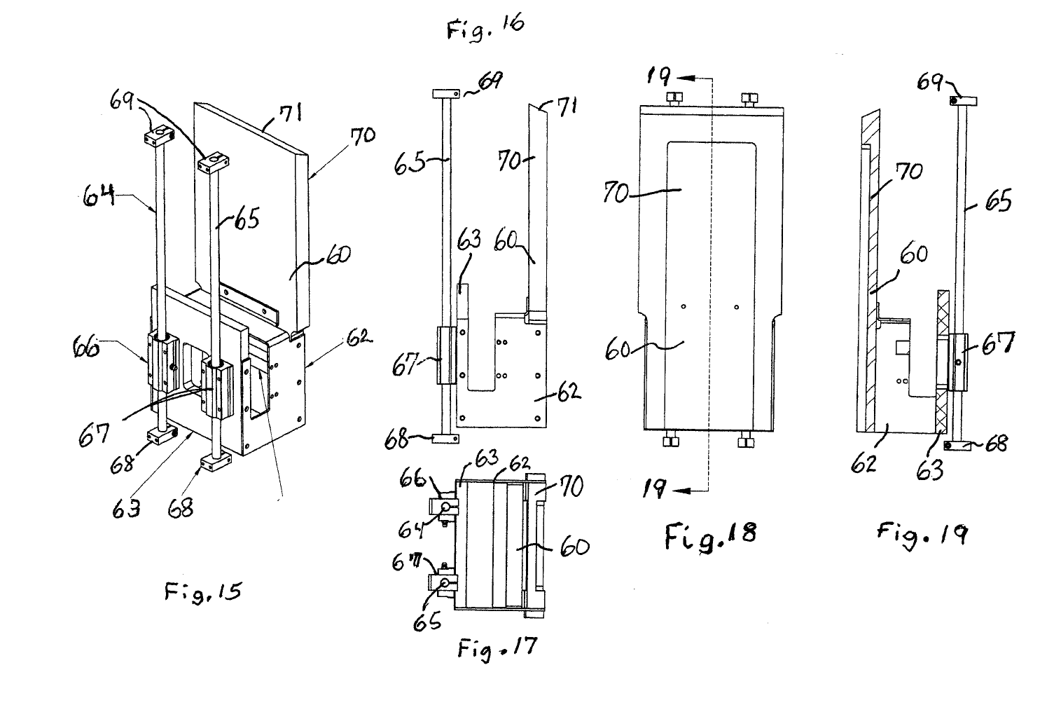

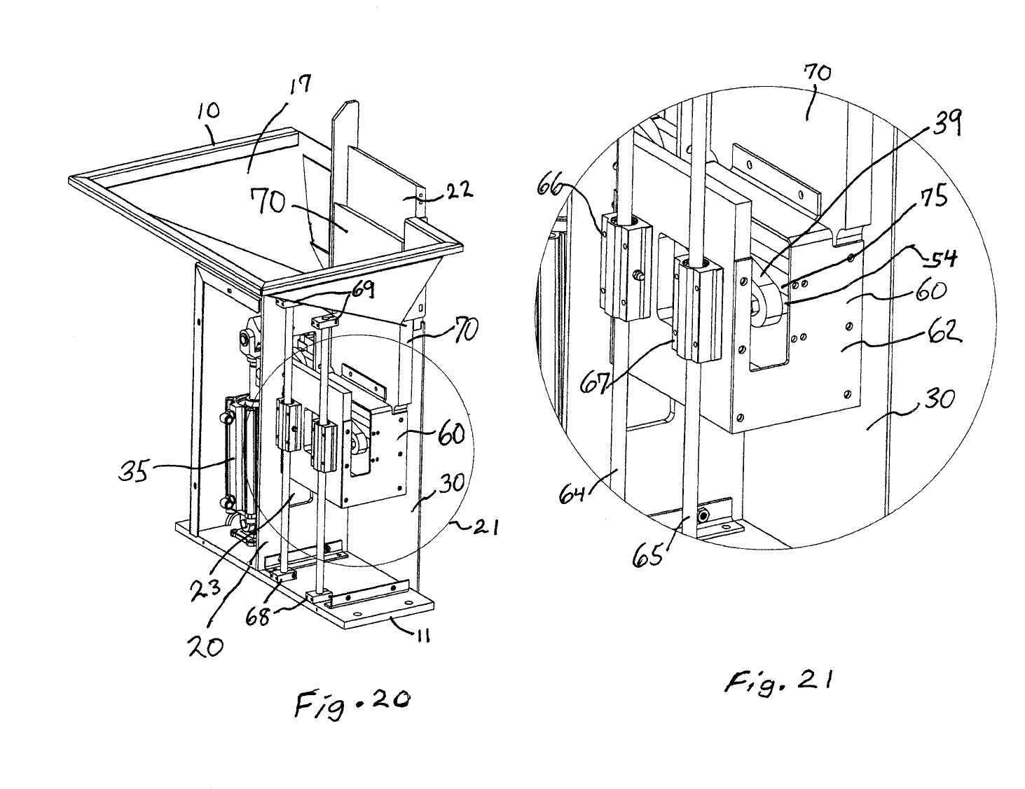

Additional features of the device 10 of the present invention for feeding parts to a manufacturing system are best understood by considering FIGS. 15 to 19 which show a carriage assembly 60 of the device of the present invention for feeding parts to a manufacturing system. FIG. 15 is a perspective view of a carriage assembly 60; FIG. 16 is a side view of the carriage assembly; FIG. 17 is a bottom view of the carriage assembly; FIG. 18 is a front elevation view of the carriage assembly; and FIG. 19 is a section view of the carriage assembly taken at line 19-19 of FIG. 18.

A carriage mount bracket 62 is fixed to a carriage base plate 63. A pair of guide rods 64, 65 are attached to the carriage base plate using a pair of linear bearings 66, 67. The linear bearings 66, 67 allow the carriage base plate 63 and parts attached to the carriage base plated to slide along the guide rods 64, 65. The linear bearings 66. 67 may be either oil impregnated brass bearings or needle bearings selected in accordance with good engineering practices. Mounting blocks 68, 69 are located at the ends of the guide rods for attaching the carriage assembly 60 to the frame assembly in a manner that will be disclosed below.

A dynamic part feeding plate 70 is fixed to the carriage mounting bracket 62 using appropriate fasteners such that the part feeding plate moves vertically along the guide rails 64, 65 with the carriage mounting bracket 62 and the carriage base plate 63. A top edge 71 of the dynamic part feeding plate 70 is beveled.

Details of the operation of the carriage assembly 60 interacting with other components of the completely assembled device of the present invention for feeding parts to a manufacturing system will be disclosed below.

Additional features of the structure and operation of the device 10 of the present invention for feeding parts to a manufacturing system are best understood by considering FIGS. 20 and 21. FIG. 20 is a perspective view of the completely assembled device of the present invention for feeding parts to a manufacturing system partially broken away to show the carriage assembly 60 and drive assembly 35 located inside the frame assembly 30. FIG. 21 is an enlarged detail of FIG. 20 showing the connection of the drive assembly 35 to the carriage assembly 60.

The drive assembly 35 is fixed to the base 11 using the double clovis pivot bracket as described above allowing the double action pneumatic cylinder to pivot about a bottom side of the cylinder. The double action pneumatic cylinder is located on a first side of the second side plate 20 of the frame assembly with the carriage assembly 35 located on the opposite side of the second side plate 20.

The mounting blocks 68 at the lower ends of the guide rods 64, 65 are fastened to the back plate 14 of the frame assembly and the mounting blocks 69 at the upper ends of the guide rods 64, 65 are attached to the back plate 14 of the frame assembly when the back plate is in its normal operating configuration.

The drive lever 39 of the drive assembly passes through the passage 23 in the second side plate 20 with the cam follower 54 on the connecting rod engaging a cam profile surface 75 (sometimes called a cam race) attached to carriage bracket 62 allowing the motion of the dynamic part feeding plate 70. In FIGS. 20 and 21 the carriage mount bracket 62 is located intermediate the upper extent and lower extent of travel of the carriage mount bracket such that the top edge of the dynamic part feeding plate 70 is below the top edge of the stationary part feeding plate 22.

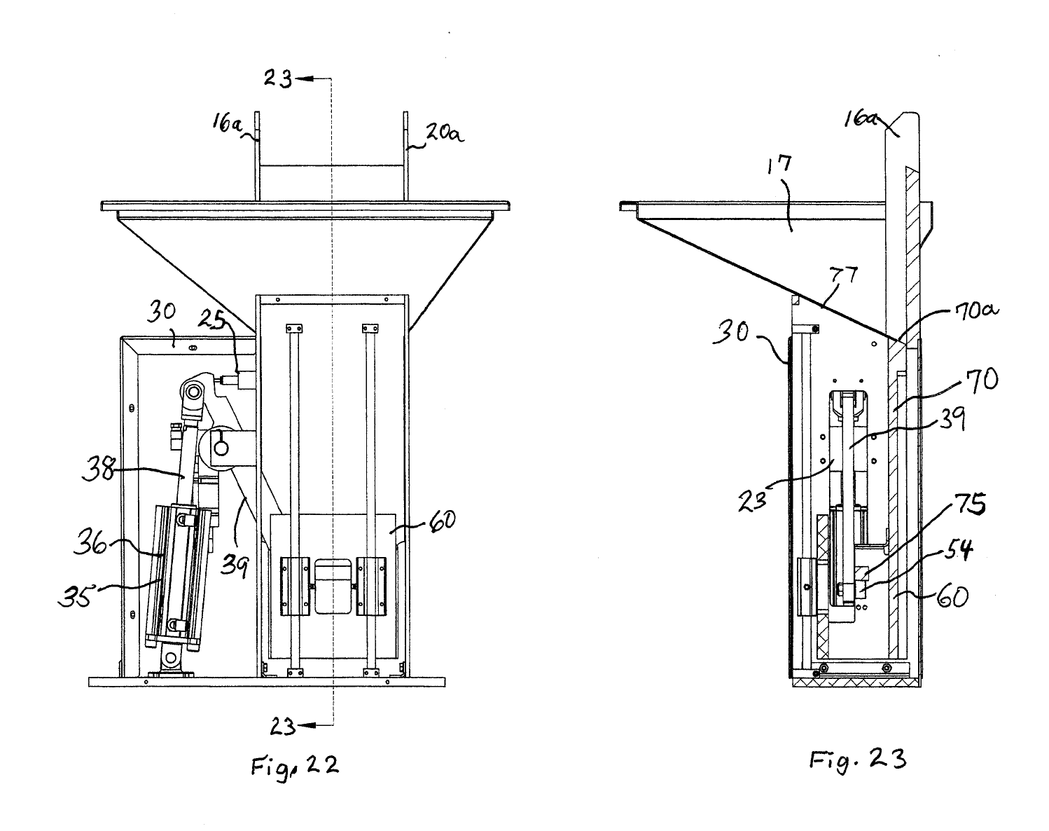

The operation of the device 10 of the present invention for feeding parts to a manufacturing system is best understood by considering FIGS. 22 to 27. FIG. 22 is a rear elevation view of the completely assembled device of the present invention for feeding parts to a manufacturing system with the rear panel of the frame assembly removed to show the drive assembly 35 and frame assembly 30, with the carriage assembly 60 at the lowest extend of its travel. FIG. 23 is a section view of the assembled device taken at line 23-23 of FIG. 22.

In FIGS. 22 and 23 the double action pneumatic cylinder 36 has the piston and piston rod 38 at the end of an extending stroke and the drive lever 39 is pivoted downward extending through the passage 23 in the second side plate of the frame assembly and the cam follower 54 engaging the cam profile surface attached to carriage bracket 62 and dynamic part feeding plate 70. The pivoting of the drive lever is limited by a bumper 25. The beveled upper edge 70a of the dynamic part feeding plate 70 is aligned with the lowest extend of a sloping inside surface 77 of the hopper 17. The parts (no shown) that are to be fed to a manufacturing system (not shown) may be loaded into the hopper. A part, or parts, will be moved by gravity onto the beveled upper edge 70a of the dynamic part feeding plate 70. Movement of the part, or parts, laterally on the beveled upper edge 70a is limited by the vertically extending support post portions 16a, 20a of the side plates 16, 20.

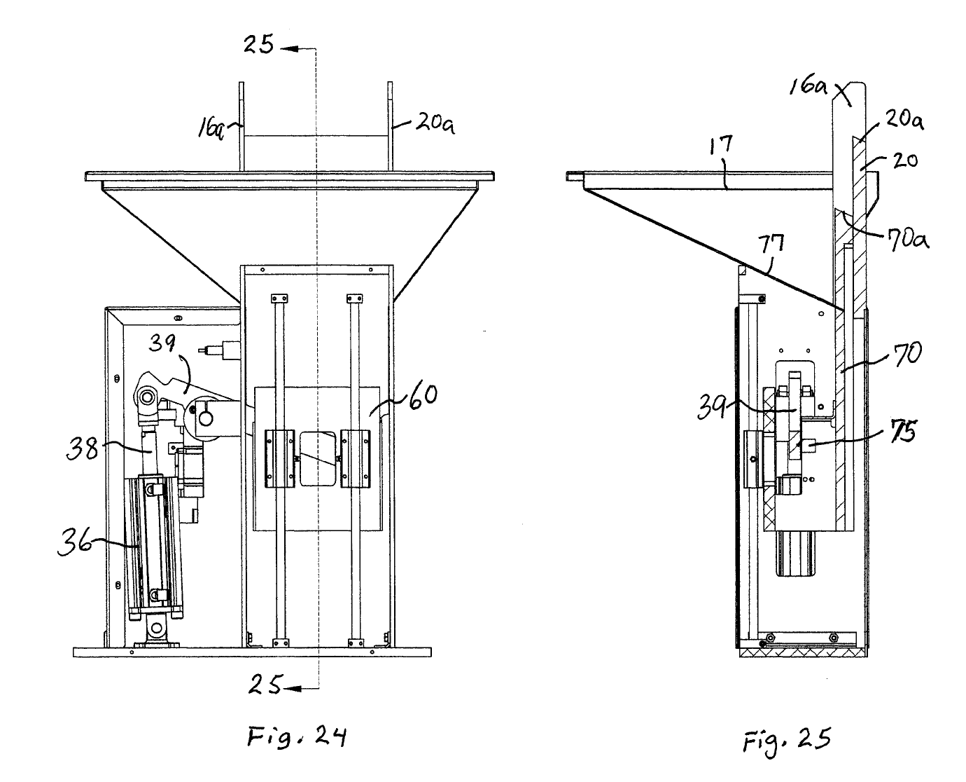

FIG. 24 is like FIG. 22 with the with the carriage assembly 60 part way between the lowest and highest extend of its travel. FIG. 25 is a section view of the assembled device taken at line 25-25 of FIG. 24.

In FIGS. 24 and 25 the double action pneumatic cylinder 36 has the piston and piston rod 38 part way through retracting stroke and the drive lever 39 is pivoted downward at a shallower angle than in FIGS. 22 and 23. The cam follower 54 continues to engage the cam profile surface in carriage bracket 62. The beveled upper edge 70a of the dynamic part feeding plate 70 is located above the lowest extend of a sloping inside surface 77 of the hopper 17 but below the beveled upper edge 22a of the stationary part feeding plate 22. The parts (not shown) that are to be fed to a manufacturing system (not shown) rest on the top beveled edge 70a of the dynamic part feeding plate 70. Movement of the part, or parts, laterally on the beveled upper edge 70a is limited by the vertically extending support post portions 16a, 20a of the side plates 16, 20.

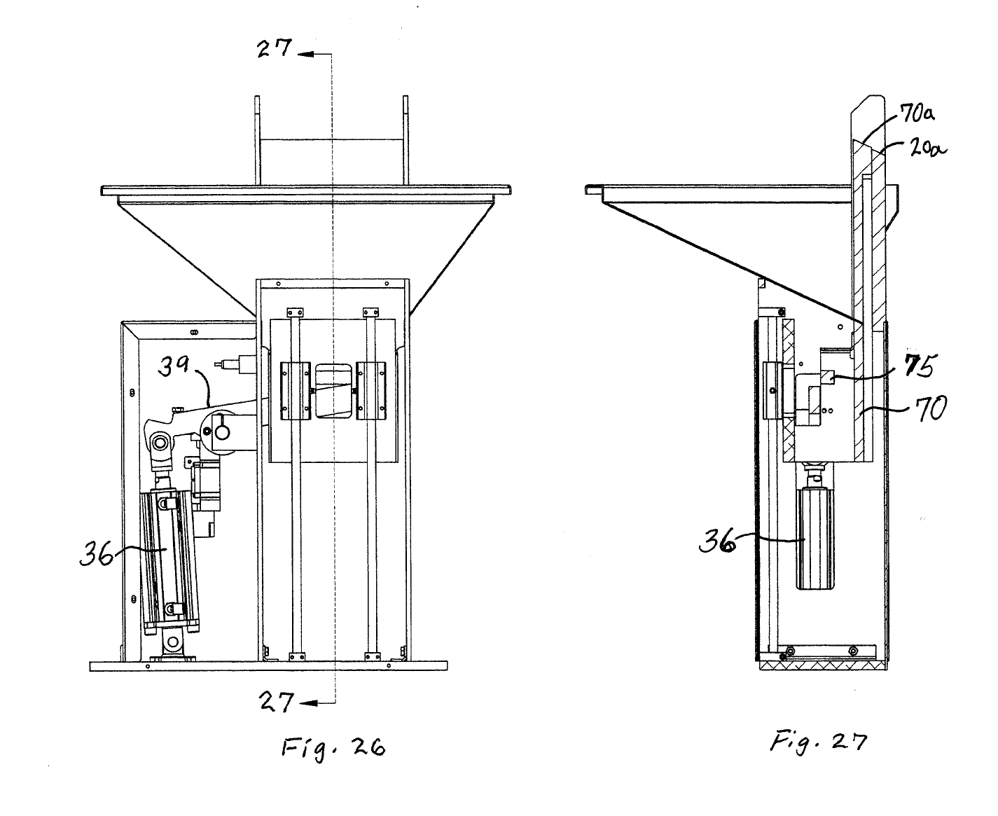

FIG. 26 is like FIG. 22 with the carriage assembly 60 at the highest extent of its travel. FIG. 27 is a section view of the completely assembled device taken at line 27-27 of FIG. 26.

In FIGS. 26 and 27 the double action pneumatic cylinder 36 has the piston and piston rod 38 at the end of a retracting stroke and the drive lever 39 is pivoted upward. The cam follower 54 continues to engage the cam profile surface in the carriage bracket 62. The beveled upper edge 70a of the dynamic part feeding plate 70 is aligned with the beveled upper edge 22a of the stationary part feeding plate 22. In FIG. 27 it is apparent that the bevel angles of the beveled upper edge 70a of the dynamic part feeding plate 70 and the beveled upper edge 22a of the stationary part feeding plate 22 are complementary. The parts (not shown) that are to be fed to a manufacturing system (not shown) move by gravity (roll) from the top beveled edge 70a of the dynamic part feeding plate 70 and then over the beveled upper edge 22a of the stationary part feeding plate 22 to a manufacturing system (no shown).

After the part, or parts, have been supplied to a manufacturing system the double acting pneumatic cylinder is supplied with air through another air port causing the piston and piston rod to make an extending stroke moving the carriage assembly back to the location shown in FIGS. 22 and 23. The rate at which the device supplies parts to a manufacturing system may be controlled with an electrically controlled air valve assembly. It is understood that the dimensions of the device may be altered to accommodate the size of the parts to be delivered to a manufacturing system.

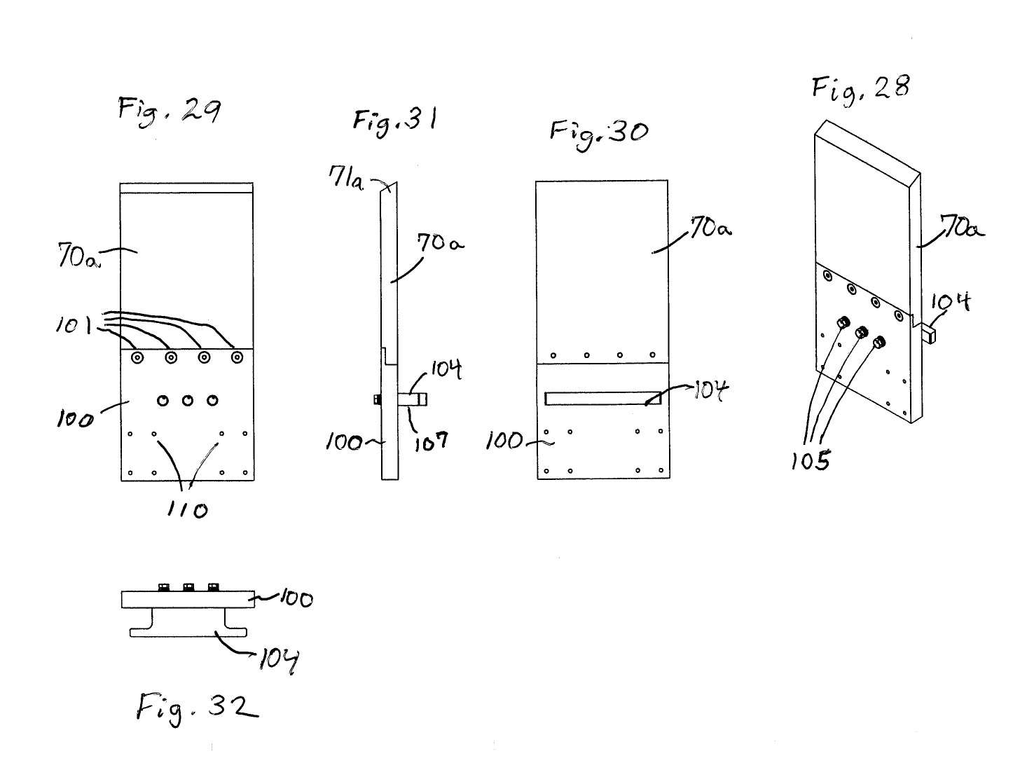

A second embodiment of a device used with an automated manufacturing system for deeding parts to the manufacturing system is substantially like the first embodiment that has been described above with the exception that the carriage assembly is eliminated. The housing of the device and the drive assembly remain the same as in the first embodiment so there is no need to address those components except as they relate to the components that are newly employed in the second embodiment. First the revisions to dynamic part feeding plate are shown in FIGS. 28-32 wherein: FIG. 28 is a perspective view of the dynamic part feeding assembly comprising a dynamic part feeding plate assembled with a mounting plate; FIG. 29 is a first elevation view of the dynamic part feeding assembly; FIG. 30 is a second elevation view of the dynamic part feeding assembly showing a side of the assembly opposite the side shown in FIG. 29; FIG. 31 is a side elevation view the dynamic part feeding assembly; and FIG. 32 is a top view of the cam plate that is fixed to the mounting plate of the dynamic part feeding assembly.

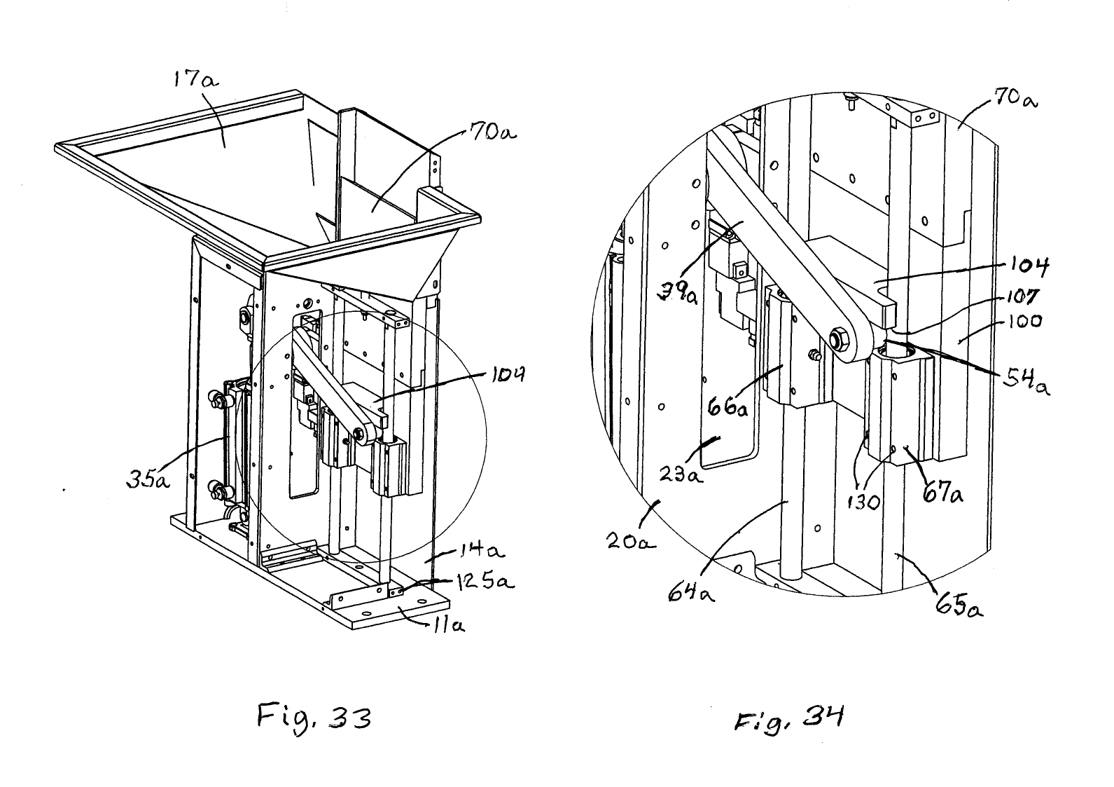

The dynamic part feeding plate 70a is substantially like the dynamic part feeding plate 70 of the first embodiment. but instead of being mounted to a carriage the dynamic part feeding plate 70a is fixed to a mounting plate 100. The mounting plate 100 will be configured to move vertically in a manner to be described below with regards to FIGS. 33 and 34. The dynamic part feeding plate 70a is in part overlapping the mounting plate 100 and a plurality of fasteners 101 secure the dynamic part feeding plate 70a to the mounting plate 100. It is understood that if desired these two parts could be made integral as a single part. A cam plate 104 is fixed to the mounting plate 100 by a plurality of fasteners 105 with the cam plate provided with a cam profile surface 107 that extends perpendicular to the mounting plate. The mounting plate is provided with a plurality of passages for receiving fasteners used to fix the mounting plate to the device in a manner that will be disclosed in FIGS. 33 and 34.

FIG. 33 is a is a perspective view of the completely assembled device of the second embodiment of the present invention for feeding parts to a manufacturing system partially broken away to show the dynamic part feeding assembly and drive assembly located inside the frame assembly. FIG. 34 is an enlarged detail of FIG. 33 showing the connection of the dynamic part feeding assembly to the guide rods. The differences between the first and second embodiments can be best understood by viewing at the same time analogous FIGS. 20 and 21 for the first embodiment.

As in the first embodiment a pair of vertically extending guide rods 64a, 65a are fixed to the base plate 11a of the housing using a guide rail mount 125a. A drive assembly 35a is like the drive assembly of the first embodiment and is located with a drive lever 39a extending through an elongated passage 23a in a second side plate 20a just as in the first embodiment. In this second embodiment the mounting plate 100 is fixed to the linear bearings 66a, 67a by a plurality of fasteners 130. A cam follower 54a is secured to the drive lever 39a as in the first embodiment. The cam follower 54a contacts the cam profile surface 107 that extends perpendicular to the mounting plate 100. As in the first embodiment the drive assembly 35a causes the drive lever 39a to move whereby the cam follower 54a in conjunction with the cam surface imparts vertical motion to the dynamic part feeding plate 70a along the back plate 14a of the housing. A top edge 71a of the dynamic part feeding plate 70a is beveled as in the first embodiment. Parts in the hopper 17a are lifted at top edge 71a of the dynamic part feeding plate 70a as described above with regards to the first embodiment.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense. It is also to be understood that the following claims are intended to cover all of the generic and specific features of the invention herein described, and all statements of the scope of the invention which, as a matter of language, might be said to fall there between.

What is claimed is:

1. A device for feeding parts to a manufacturing system, the device comprising:
(a) a housing that includes a base at a lower end of the housing and a hopper at an upper end of the housing for holding parts;
(b) a drive assembly having a lower end of the drive assembly fixed to the base of the housing, the drive assembly comprising a piston and piston rod in a cylinder, the piston rod being oriented vertically, an end of the piston rod distal from the piston is fixed to a drive lever in a by a hinge mechanism, and a cam follower is secured to the drive lever with the cam follower spaced apart from the piston rod;
(c) a pair of vertically extending spaced apart guide rods, each guide rod having a lower end that is fixed to the base plate, each guide ford provided with a linear bearing that slides along the guide rod; and
(d) a dynamic part feeding plate that is fixed to a mounting member, the mounting member being fixed to each of the linear bearings, the mounting member provided with a cam member having a cam profile surface that mates with the cam follower of the driver assembly drive lever to move the dynamic feeding plate vertically through the hopper of the housing along a wall of the hopper.

2. The device feeding parts to a manufacturing system according to claim 1 wherein the drive assembly comprises a double action pneumatic cylinder.

3. The device feeding parts to a manufacturing system according to claim 1 wherein the drive assembly comprises a double action hydraulic cylinder.

4. The device feeding parts to a manufacturing system according to claim 1 wherein the drive assembly comprises a double action electromagnetic cylinder device.

5. The device feeding parts to a manufacturing system according to claim 1 wherein the mounting member that fixes the dynamic part feeding plate to the linear bearings is a carriage with a carriage wall that is fixed to the linear bearings and the dynamic part feeding plate fixed to a spaced apart from the carriage wall, the cam follower of the drive lever the and cam profile surface being interposed between the carriage wall and the dynamic part feeding plate.

6. The device feeding parts to a manufacturing system according to claim 1 wherein the mounting member that fixes the dynamic part feeding plate to the linear bearings is a mounting plate that is fixed to the dynamic part feeding plate and is located below the dynamic part feeding plate of vertically extending spaced apart guide rods being located between (a) the mounting plate and (b) mating of the cam follower of the drive lever the and cam profile surface.

7. The device feeding parts to a manufacturing system according to claim 2 wherein the mounting member that fixes the dynamic part feeding plate to the linear bearings is a carriage with a carriage wall that is fixed to the linear bearings and the dynamic part feeding plate fixed to a spaced apart from the carriage wall, the cam follower of the drive lever the and cam profile surface being interposed between the carriage wall and the dynamic part feeding plate.

8. The device feeding parts to a manufacturing system according to claim 2 wherein the mounting member that fixes the dynamic part feeding plate to the linear bearings is a mounting plate that is fixed to the dynamic part feeding plate and is located below the dynamic part feeding plate of vertically extending spaced apart guide rods being located between (a) the mounting plate and (b) mating of the cam follower of the drive lever the and cam profile surface.
